(19) United States
(12) Patent Application Publication
(10) Pub. No.: US 2014/0261003 A1
(43) Pub. Date: Sep. 18, 2014

(54) PORTION CONTAINER COMPRESSION SYSTEM

(71) Applicant: Thermos K.K., Tsubame-shi (JP)

(72) Inventors: Takahiro Maruyama, Tsubame-shi (JP); Shin Matsuyama, Tsubame-shi (JP)

(73) Assignee: Thermos K.K., Tsubame-shi (JP)

(21) Appl. No.: 14/206,961

(22) Filed: Mar. 12, 2014

(30) Foreign Application Priority Data
Mar. 14, 2013 (JP) 2013-051357

(51) Int. Cl. A47J 31/18

(52) U.S. Cl. CPC A47J 31/18
USPC 99/318

(57) ABSTRACT

Provided is a portion container system having improved operability and user-friendliness. The system includes a receiving portion, for stowing a container on a system main body, and a rotatable handle. The container includes a peeling induction portion. The container, stowed in the receiving portion, is allowed to be compressed by swinging a handle. The container can be squeezed with the handle using the leverage, thus improving a convenience and allowing the system to be formed compact compared to a rotary apparatus. Since the container is obliquely placed in the receiving portion, the content ejected hardly splashes. Since the receiving portion is located below the rotation center shaft of the handle, the container is pressed with the handle having the rotation center shaft located above the receiving portion, thereby causing the container to be pressed with the force pushing down the handle, thus allowing for easy application of force.

### CROSS REFERENCE TO RELATED APPLICATIONS

This application claims the benefit of Japanese Patent Application No. 2013-051357, filed Mar. 14, 2013. The contents of this application are incorporated herein by reference in their entirety.

### BACKGROUND OF THE INVENTION

1. Field of the Invention

The present invention relates to a portion container compression system capable of pushing out a content of a portion container by compressing the same.

2. Description of the Related Art

Conventionally, as such a kind of system, there have been known a liquid feeding system as disclosed in WO2006/053635 (or JP Un-examined Patent Publication No. 2008-520298) and another liquid feeding system as disclosed in Japanese Pat. No. 4485869. The liquid feeding system of WO2006/053635 has a communicative operation structure established by providing a spike on a portion holder. Particularly, the spike serves to bore a hole in a portion container stowed in a concave space of the portion holder such that a housing space of a container body and a liquid-containing section are allowed to be communicated with each other through a communication hole. As for the liquid feeding system of Japanese Pat. No. 4485869, a communicative operation structure is established by providing on a portion holder a cutter used to break a seal lid of a mouth section of a portion container.

Since each of the conventional liquid feeding systems described above has the communicative operation mechanism established by providing on the portion holder a spike or a cutter, the structure thereof becomes inevitably complex, thus making it difficult to wash the system after use, even involving a risk of injuring hands due to the spike or the cutter.

In view of the aforementioned problems, there has also been known a liquid feeding system as disclosed in Japanese Unexamined Patent Application Publication No. 2012-135518. This system includes: a portion container formed by sealing a mouth section of a container body; a portion holder having a concave space capable of stowing the portion container; and a communicative operation mechanism established by forming on a bottom section of the concave space of the portion holder a communication hole for communicating the concave space with a liquid-containing section provided therebelow. That is, a housing space of the system main body and the liquid-containing section are communicated with each other through the communication hole. Particularly, the communicative operation mechanism is configured as follows. That is, there is also provided a compression mechanism capable of compressing the portion container stowed in the concave space. Here, in accordance with the way the portion container is compressed by the compression mechanism, formed on this portion container is a peeling induction portion allowing a content to leak out as the seal lid is partially peeled from the portion container body. Specifically, with the portion container being stowed in the concave space, the peeling induction portion is positioned at a region of the bottom section and faces the communication hole.

According to the liquid feeding container system of JP2012-135518, the portion container is stored in the concave space of the portion holder while its main beverage liquid is retained in the liquid-containing section. Operation of the compression mechanism allows the portion container to be pressed, which in turn causes a part of the seal lid to be peeled off from the portion container body due to the peeling being induced by an peeling induction portion in response to an elevated internal pressure inside the portion container, enabling the content of the portion container to be leaked out and led into a liquid receiver through the communication hole, thus providing a safe and easily-cleanable liquid feeding container system.

However, even such safe and easily-cleanable liquid feeding container system of JP2012-135518 has the following problems that remain to be solved for achieving improved usability.

According to the liquid feeding container system of JP2012-135518, container system requires a comparatively large space to store the entire portion container therein when the container system employs a screw mechanism for pressing and crushing the portion container. Moreover, the rotating torque of the closing lid is difficult to control at the main container side because the required torque depends on the stiffness of the closing lid portion container and the tightness of the seal. Further, the closing lid needs to be rotated several times in order for the lid to be sufficiently screwed down. Furthermore, the bottom surface of the portion container to be crushed with a screw mechanism is preferably to be a substantially horizontal flat surface when the portion container is put within the storage space, whereas the mouth section of the portion container needs to be sloped to some extent to prevent spouting out. For this reason, the bottom section of the storage chamber as well as the mouth section of the portion container are sloped to conform the mouth section to the bottom section so that the bottom section of the portion container is arranged to be substantially horizontal when the mouth section of the portion container is placed upon the bottom section of the storage chamber. As a result, volumetric efficiency of the portion container tends to be impaired since the mouth section of the portion container needs to be obliquely formed.

It is, therefore, an object of the present invention to improve the portion container compression system in terms of operability and user-friendliness.

### SUMMARY OF THE INVENTION

A first aspect of the present invention is a portion container compression system comprising a system main body; a portion container including an easily unsealable portion; a receiving portion for installing the portion container on the system main body; and a rotatable handle, in which the portion container installed in the receiving portion is allowed to be compressed by swinging the handle.

A second aspect of the present invention is a portion container compression system in which the portion container is obliquely installed in the receiving portion.

A third aspect of the present invention is a portion container compression system, in which the receiving portion is located below a rotation center shaft of the handle.

A fourth aspect of the present invention is a portion container compression system, in which the system main body is disposed on a main container.

A fifth aspect of the present invention is a portion container compression system, in which a mouth is provided in a region above the receiving portion for drinking a beverage in the main container.

A sixth aspect of the present invention is a portion container compression system, in which a lid body with a waterproof function is provided on an upper portion of the system main body.

A seventh aspect of the present invention is a portion container compression system, in which a locking mechanism locks the handle at an initial position.

An eighth aspect of the present invention is a portion container compression system, in which the locking mechanism is disposed under the handle.

A ninth aspect of the present invention is a portion container compression system, in which a cutout section is formed in a portion of the mouth, the portion located to receive the swinging handle.

A portion container compression system according to the first aspect of the invention can be squeezed with the handle by applying the principle of leverage, thereby improving the convenience and allowing the system to be formed compact as compared to a rotary apparatus. Further, the handle can also be used to carry the system, thus improving the convenience as well.

According to the second aspect of the invention, the portion container is obliquely disposed. Therefore the content in the portion container is less likely to splash upward when it spouts out.

According to the third aspect of the invention, the portion container is to be pressed with the handle having its rotation center shaft located above the receiving portion, thereby enabling the portion container to be compressed with the force pushing down the handle, thus allowing for easy application of force.

According to the fourth aspect of the invention, a condensed beverage out of the squeezed portion container can be diluted with a water or hot water, putting ice to the water whenever necessary, in order to prepare a beverage.

According to the fifth aspect of the invention, the user is allowed to directly drink the beverage in the main container, thus further improving the convenience.

According to the sixth aspect of the invention, a prepared beverage can be carried with the lid body shut, thus further improving the convenience.

According to the seventh aspect of the invention, the system can be carried and the user can drink the beverage with the handle locked.

According to the eighth aspect of the invention, the handle not only can be easily unlocked, but also little affects the entire appearance resulting in a superior design feature.

According to the ninth aspect of the invention, not only the rotational center of the handle can be lowered, but the portion container is allowed to be disposed in a deeper location, thus achieving a high designability and saving space.

### BRIEF DESCRIPTION OF THE DRAWINGS

FIG. 1 is a cross-sectional view of a first embodiment of the present invention.

FIG. 2 is a side view of the first embodiment of the present invention.

FIG. 3 is an enlarged cross-sectional view of a locking mechanism of the first embodiment of the present invention.

FIG. 4 is an enlarged perspective view of the locking mechanism of the first embodiment of the present invention, in which a cross-section of a part of this locking mechanism is shown.

FIG. 5 is a perspective view of an essential section of a handle of the first embodiment of the present invention.

FIG. 6 is a side view of a region around a handle attachment portion of the first embodiment of the present invention.

FIG. 7 is a cross-sectional view of a state where the handle has been swung in the first embodiment of the present invention.

FIG. 8 is a cross-sectional view showing how a portion container is pushed and squeezed in the first embodiment of the present invention.

FIG. 9 is a perspective view of a region around a receiving portion of the first embodiment of the present invention.

FIG. 10 is a perspective view showing the receiving portion of the first embodiment of the present invention from underneath, with a main container being cross-sectioned.

FIG. 11 is a perspective view showing how the portion container is pushed and squeezed in the first embodiment of the present invention.

FIG. 12 is a perspective view of a system main body of the first embodiment of the present invention.

FIG. 13 is a cross-sectional view of a lid body-side water stop member of the first embodiment of the present invention.

FIG. 14A is a plane view of the portion container of the first embodiment of the present invention.

FIG. 14B is a perspective view of the portion container of the first embodiment of the present invention.

FIG. 14C is a vertical side view of the portion container of the first embodiment of the present invention.

FIG. 14D is a side view of the portion container of the first embodiment of the present invention.

FIG. 15 is a cross-sectional view showing how a portion container of a second embodiment of the present invention is pushed and squeezed.

### DESCRIPTION OF THE EMBODIMENTS

Preferred embodiments of the present invention are described with reference to the accompanying drawings. However, the embodiments described hereunder shall not limit the contents of the present invention that are described in Claims. Further, not all elements introduced hereunder are necessarily the essential elements of the present invention.

### First Embodiment

With reference to FIG. 1 to FIG. 17, described is a first embodiment where the present invention is applied to a portion container compression system. The portion container compression system 1 can be disposed on or attached to a metal bottomed container 2 of a handheld size. In this embodiment, the portion container compression system 1 is detachably attached to an upper opening section 3 of the main container 2.

The main container 2 has a heat-insulating double-layered structure where an inner cylinder 5 and an outer cylinder 4 are coupled to each other by integrally joining together the edges thereof in the upper opening section 3, defining a space between the outer cylinder 5 and the inner cylinder 4 that serves as a vacuum heat-insulating layer 6. Here, the upper inner circumference of the outer cylinder 4 is formed with a first female screw portion 7 allowing the portion container compression system 1 (referred to as compression system hereunder) to be screwed thereinto. The compression system 1 serves to compress a portion container 8.

The compression system 1 includes: a mouth body 10 serving as a system main body; a ring portion 11 fitted onto the mouth body 10; a shoulder member 12 that is provided below the ring portion 11 and is externally attached to the upper opening section 3 of the container 2; and a handle 13 pivotally attached to one end of the shoulder member 12, all of which are made of a synthetic resin.

The mouth body 10, made of a synthetic resin, is integrally formed of an upper protruding wall 14 and a lower cylindrical portion 16. The upper protruding wall 14 has a cylindrical shape, and is attached above the upper opening section 3 in a manner coaxial to the central axis thereof. The lower cylindrical portion 16 is disposed below the upper protruding wall 14 in such a fashion that the lower cylindrical portion 16 is continuously connected to the upper protruding wall 14 through a taper cylindrical portion 15 whose diameter shrinks downward. Particularly, formed inside the mouth body 10 is a communication passage 17 that is parallel to the aforementioned central axis and serves to communicate the inner and outer regions with each other. That is, the communication passage 17 is defined by the inner walls of the upper protruding wall 14, the taper cylindrical portion 15 and the lower cylindrical portion 16. The communication passage 17 communicates an outer region and an inner region of the main container 2 with each other. An upper end of the upper protruding wall 14 is formed as a mouth section 14A, and the left and right sections of this mouth section 14A are suitable for use in drinking.

Further, provided on the outer circumference of the lower cylindrical portion 16 is a first male screw 18 engageable with the first female screw portion 7. Further, a mouth body-side water stop member 19 made of, for example, a rubber seal is provided on the lower end circumference of the lower cylindrical portion 16. Here, a cross-sectional surface of the mouth body-side water stop member 19 is substantially formed into a “U” shape. Further, the mouth body-side water stop member 19 itself is formed into an annular shape whose center is located on the aforementioned central axis. The mouth body-side water stop member 19 is fitted onto a mouth body-side attachment portion 20 that is annularly disposed on the lower end circumference of the lower cylindrical portion 16 and has a center also located on the aforementioned central axis. In the meantime, the outer circumference of the mouth body-side water stop member 19 is configured to be able to abut against a small-diameter portion 3A formed in the lower region of the upper opening section 3.

The shoulder member 12 includes a cover portion 21 capable of abutting against the upper region of the upper opening section 3; and a cylindrical portion 22 vertically extending downward from the cover portion 21. In fact, the shoulder member 12 is formed independently from the mouth body 10. Further, an annular engagement protrusion 23 is provided on the inner surface of the cylindrical portion 22, and an annular engagement concave portion 24 is provided on the outer circumference of the upper opening section 3. That is, the shoulder member 12 is to be attached to the upper opening section 3 in a fixed manner by engaging the engagement protrusion 23 with the engagement concave portion 24. The engagement concave portion 24 is formed on the outer circumference of the outer cylinder 4.

Further, an inward annular engagement protrusion 26 is provided on the upper section of the ring portion 11, and an annular engagement concave portion 27 is provided on the outer circumference of the upper protruding wall 14. The ring portion 11 is to be attached to the lower portion of the upper protruding wall 14 in a fixed manner by engaging the engagement protrusion 26 with the engagement concave portion 27. In this attachment state, the ring portion 11 covers the upper portion of the shoulder member 12, and a clearance 25 is formed between the upper opening section 3 and the inner surface of the ring portion 11.

An attachment receiving portion 31 for handle is provided on one end of the outer circumference of the shoulder member 12. This attachment receiving portion 31 includes: a pair of left and right attachment arm portions 32, 32 protruding obliquely upward; and a left and right engagement arm portions 33, 33 that protrude outward and are continuously connected to the lower sections of the attachment arm portions 32, 32. As shown in FIG. 2, a substantial “L” shape is formed due to the fact that the attachment arm portions 32 and the engagement arm portions 33 are continuously joined together. Further, the engagement arm portions 33 are so formed that the front end sections thereof point obliquely downward. In addition, a rotation center shaft 34 of the handle 13 is provided between the pair of left and right attachment arm portions 32, 32, and the center of this rotation center shaft 34 is located above the upper opening section 3.

The handle 13 integrally includes: an attachment portion 35 to be disposed between the left and right attachment receiving portions 31, 31; and a substantially L-shaped handle body 36 provided on the front end of the attachment portion 35. Specifically, the attachment portion 35 is pivotally joined to the attachment arm portions 32 through the rotation center shaft 34. In fact, the attachment portion 35 of the handle 13 is integrally provided on the handle body 36 in a manner such that the attachment portion 35 is particularly disposed in a direction opposite to the direction along which the handle body 36 is bended.

Further, the handle body 36 includes: a handle base portion 36K that is engageable with the engagement arm portions 33; a handle front end portion 36S extending downward from the front end of the handle base portion 36K; and a bended portion 36C provided between the handle base portion 36K and the handle front end portion 36S. Furthermore, a left and right concave side walls 37, 37 are formed, in a left-right width direction, on both sides of the handle attachment portion 35 and the handle base portion 36K, the left and right concave side walls 37, 37 substantially corresponding to the width of the attachment receiving portion 31. That is, as for the handle 13, the left-right width of the section where the concave side walls 37, 37 are formed is smaller than other sections, and the attachment arm portions 32 and the handle base portion 36K are disposed between the left and right attachment receiving portions 31, 31.

At an initial position also referred to as a fixed usage position, the handle front end portion 36S points downward, and handle boundary portions 38 each having a clearance are formed at front ends 33S of the engagement arm portions 33. Due to a locking member 41 of a locking mechanism 40 for fixing the handle 13 at the initial position, a given clearance can be secured at the handle boundary portions 38 when locked. Further, as shown in FIG. 9, the handle boundary portions 38 are formed on the front end regions of the concave side walls 37.

The locking mechanism 40 includes a downward protrusion 42 that is disposed on the outer circumference of the shoulder member 12 and serves as a locking engagement portion. Specifically, this downward protrusion 42 is provided below the attachment receiving portion 31. More specifically, a transverse part 39 is so provided on the outer circumference of the shoulder member 12 that the transverse part 39 protrudes substantially horizontally. Here, a pair of downward protrusions 42 are provided on the lower portion of the front end region of the transverse part 39 in a manner such that a clearance is formed between the downward protrusions 42 in the left-right direction. Further, a concave portion 43 whose base end region and lower portion are both opened, is formed in an area ranging from the handle base portion 36K to the upper portion of the handle front end portion 36S. Disposed in this concave portion 43 is the locking member 41 integrally including: a substantially cylinder-shaped shaft insertion portion 45 for an attachment shaft 44 to be inserted therethrough; and a substantially bow-shaped curved portion 46 that is convex upward. Particularly, the shaft insertion portion 45 is substantially provided above a central region of the curved portion 46 in the longitudinal direction, and a through hole 47 serving as an engagement receiving portion is bored in the base end region (a region close to the mouth body 10) of the curved portion 46. More particularly, the downward protrusions 42 can engage with or disengage from this through hole 47. Each downward protrusion 42 is formed into the shape of a board extending in the left-right direction. There, the attachment shaft 44 is to be loosely inserted through the shaft insertion portion 45 such that the attachment shaft 44 can be attached to the handle 13 on both sides of the concave portion 43. In this way, the locking member 41 is allowed to be pivotally disposed in the concave portion 43 of the handle 13 around the attachment shaft 44. As for the concave portion 43, only the lower portion thereof is opened, whereas a front-back and a left-right regions thereof are sealed. Further, the under surface of the curved portion 46 is formed into a curved shape conforming with the under surface of the handle 13.

In addition, the locking mechanism 40 includes a biasing unit 48 for rotationally biasing the locking member 41. This biasing unit 48 is a torsion coil spring fitted onto the shaft insertion portion 45, and serves to bias the locking member 41 in a direction allowing the downward protrusions 42 to engage with the through hole 47. Specifically, end portions 48A, 48B of the biasing unit 48 serve to bias the concave portion 43 and a rear surface 46U of the locking member 41 such that an engaged state can be maintained. Moreover, the concave portion 43 is provided with an abutment receiving portion 49 allowing the front end of the curved portion 46 to abut thereagainst when swinging the locking member 41. Here, the front end upper portion of the curved portion 46 is formed as a front end-region abutting portion 50. Moreover, the front end region of the curved portion 46 is formed as a control portion 46S of the locking member 41. This control portion 46S is provided with a plurality of protrusions 46D that are aligned in the left-right direction. Particularly, the end portion 48A of the biasing unit 48 can engage with the rear surface 46U of the front end region of the control portion 46S. Further, a cover portion 46K that is curved upward is integrally provided on the base end region of the curved portion 46. This cover portion 46K has an arc-like shape centering around the attachment shaft 44, and serves to hide the biasing unit 48 by covering the same. For this reason, as shown in FIG. 7 or other drawings, the biasing unit 48 is hardly visible due to the cover portion 46K when, for example, swinging the handle 13.

Further, slanted portions 42A serving as guiding portions are partially formed on the edges of the outer regions of the downward protrusions 42. These slanted portions 42A allow an end portion 46T of the base end region of the curved portion 46 to engage therewith. This base end-region end portion 46T is substantially formed into a curved shape that has already been chamfered. Specifically, as a result of swinging the handle 13 of an unlocked state toward the initial position, the base end-region end portion 46T will abut against and engage with the slanted portions 42 such that the locking member 41 will then swing against the bias of the biasing unit 48, thereby allowing the through hole 47 to be clamped on the downward protrusions 42 due to the bias of the biasing unit 48 after the base end-region end portion 46T has passed under the downward protrusions 42. Here, the slanted portions 42A are slanted inward (toward the mouth body 10) from top down. Further, vertical edge portions 42B are formed inside the downward protrusions 42. Furthermore, as shown in FIG. 4 or other drawings, an outer edge portion 47A of the through hole 47 is slanted along the slanted portions 42A, and an inner edge portion 47B of the through hole 47 is formed along the vertical edge portions 42B in the vertical direction.

Particularly, as shown in FIG. 1, a locked state of the handle 13 refers to a state where the downward protrusions 42 are engaged with the through hole 47. There, as a result of pushing the control portion 46S upward, the locking member 41 will rotate toward an unlocked direction against the bias of the biasing unit 48 such that the handle 13 will then be turned into the unlocked state before the front end-region abutting portion 50 of the curved portion 46 abuts against the abutment receiving portion 49, thus allowing the handle 13 to be swung upward. Meanwhile, as shown in FIG. 5, in a state where the locking member 41 is not being operated, a base end-region upper surface 46J of the curved portion 46 abuts against a left and right lower edges 36G, 36G of the handle base portion 36K due to the biasing unit 48, thus allowing the locking member 41 to be positioned. Here, as a result of swinging the handle 13 downward from such positioned state, the base end-region end portion 46T of the curved portion 46 will be guided by the slanted portions 42A such that the through hole 47 will then be clamped on the downward protrusions 42, thereby allowing the handle 13 to be positioned and fixed at the initial position.

In such case, as shown in FIG. 3 and FIG. 4 or other drawings, provided on the transverse part 39 is an elastic member 57 that is composed of a rubber packing or the like and serves to bias the handle. This elastic member 57 integrally includes: a base portion 57A sandwiched and fixed between the upper surface of the transverse part 39 and the lower edge of the shoulder member 12; and an abutment portion 57B formed as a convexly curved surface. There, a clearance is provided between the abutment portion 57B and the base portion 57A for the purpose of allowing the abutment portion 57B to deform. Specifically, when the handle 13 is in the locked state, the abutment portion 57B is abutted against by the inner surface of a bended portion 35C located between the handle attachment portion 35 and the handle body 36. Here, as shown in FIG. 3 or other drawings, the abutment portion 57 undergoes an elastic deformation such that the handle 13 can be pivotally biased upward due to an elastic restorability of the abutment portion 57, as indicated by an arrow marked as “Y” in FIG. 4. In this way, the handle 13 is prevented from swinging downward such that the engaged state of the locking member 41 and the downward protrusions 42 is maintained. Further, the vertical edge portions 42B of the downward protrusions 42 abut against the inner edge portion 47B of the through hole 47 at this engaged state.

As shown in FIG. 1 and FIG. 2, at the initial position of the handle 13, the under surface of the curved portion 46 is formed into such a curved shape that it is continuous with the under surface of the handle front end portion 36S.

Disposed inside the mouth body 10 is a receiving portion 51 allowing the portion container 8 to be detachably attached thereto. In fact, the portion container 8 is to be obliquely mounted on the upper portion of the receiving portion 51. Further, the receiving portion 51 is positioned below the rotation center shaft 34. Furthermore, the receiving portion 51 is disposed in a region inside the mouth body 10 that is close to the handle 13, and a transverse protruding portion 52 is provided on and protrudes inward from one end of the inner surface of the lower cylindrical portion 16. The area of this protruding portion 52 is about a half of a cross-sectional area of the inner circumference of the lower cylindrical portion 16. An inner edge 52F of this protruding portion 52 is concavely formed outward, and is located away from the center of the mouth body 10 in the outward direction. The protruding portion 52 is configured as a receiving board.

Further, a central holding claw 53 is provided on a central region of the protruding portion 52 in the left-right direction. Furthermore, receiving claw portions 54, 54 protruding toward the central region of the mouth body 10 are formed on the left and right sides of the central holding claw 53 in a manner such that the central holding claw 53 is positioned between the receiving claw portions 54, 54. Here, each receiving claw portion 54 is slanted upward from a region close to the handle 13 toward the central region of the mouth body 10. Particularly, an upper surface 54J of each receiving claw portion 54 is formed at an angle of 20 to 70 degrees, preferably 50 degrees with respect to the horizontal plane. More particularly, the front end of each receiving claw portion 54 is formed into a curved shape. In fact, the aforementioned angle is determined such that a virtual extended line of the upper surface 54J may intersect with the inner circumferential surface of the inner cylinder 5. That is, an angle of not smaller than 20 degrees allows a content to be ejected into the main container 2 without strongly hitting the lower cylindrical portion 16. Moreover, an angle of smaller than 70 degrees is preferable due to the fact that an angle of larger than 70 degrees causes the portion container 8 to be squeezed with the handle front end portion 36S standing, though depending on the shape of the portion container 8. Since the portion container 8 can be squeezed with the handle front end portion 36S standing, the portion container 8 is allowed to be squeezed from an oblique direction.

The central holding claw 53 has: an under surface 53K that is distant from and substantially parallel to the upper surface 54J of each receiving claw portion 54; and a holding portion 55 capable of holding a section of the portion container 8 that is close to a vertical groove portion 69 such that the portion container 8 does not rise when squeezed. This holding portion 55 is formed upward, and a lower end 55K thereof is formed into a sharp-pointed shape. Further, a step portion 56 is formed between the base end of the upper surface 54J of each receiving claw portion 54 and the protruding portion 52.

An example of the portion container 8 is described hereunder. As for this portion container 8, a flange portion 62 is circumferentially provided on the opening section of a portion container body 61 made of a synthetic resin. Further, a seal lid 63 formed of a resin sheet such as an aluminum laminate film is adhered to the upper surface of the flange portion 62 through thermal welding or the like. Here, a container space 64 is formed inside the portion container body 61. Further, the portion container body 61 is formed into an accordion and cylindrical shape, and is thus capable of freely expanding and contracting in the vertical direction. Furthermore, formed on the portion container 8 is a peeling induction portion 65 serving as an easily unsealable portion that allows the content to leak out as a result of peeling a part of the seal lid 63 off the portion container body 61 when using the handle 13 to compress the portion container 8.

The portion container body 61 is so formed that it is smaller toward a bottom surface portion 66 from the opening section thereof. In addition, since a step portion 67 is also provided on the portion container body 61, the section of the portion container body 61 that is below the step portion 67 is formed smaller than that above the step portion 67. In fact, this step portion 67 allows the portion container body 61 to be formed into an accordion and cylindrical shape. The bottom surface portion 66 is formed as a flat surface, and may have either a round shape or a square shape. Moreover, the bottom surface portion 66 is formed at a slight angle with respect to the flange portion 62. Specifically, this angle is preferably not larger than 15 degrees from the perspective of the volume efficiency of the portion container 8.

Further, as shown in FIG. 14A to FIG. 14 D, the portion container 8 has a sharp-pointed protrusion 68 that is formed on the side surface of the portion container body 61 and protrudes inward. That is, the aforementioned peeling induction portion 65 is configured in a manner such that a part of the seal lid 63 is to be peeled from the sharp-pointed protrusion 68 when subjected to a force pushing and opening the seal lid 63 outward. This force is applied when using the handle 13 to contract the portion container body 61 such that the inner pressure thereof increases. Further, since the sharp-pointed protrusion 68 protrudes inward, the vertical groove portion 69 concaved inward is vertically formed on the outer surface of the sharp-pointed protrusion 68. In this way, regions of the portion container body 61 that are located on both sides of the vertical groove portion 69 protrude outward. Specifically, the vertical groove portion 69 serves as an engagement portion for the portion container 8.

Further, provided on the mouth section 14A of the mouth body 10 is a cutout section 70 corresponding to the handle 13. This cut-out section 70 includes: a body-side cutout section 70A formed by cutting out a part of the upper protruding wall 14; and a ring portion-side cutout section 70B formed by cutting out a part of the ring portion 11. This ring portion-side cutout section 70B is formed into the shape of a concave portion obtained by concaving the upper edge of the ring portion 11 and the outer circumference thereof. The width of this cutout section 70 is formed larger than that of the handle 13. As shown in FIG. 7, the cutout section 70 allows the handle 13 to be rotated to a position of proximity where the handle front end portion 36S is positioned in the vicinity of the upper end of the other side of the upper protruding wall 14. Also at such position of proximity, the bended portion 36C is positioned in the vicinity of the bottom section of the cutout section 70.

In this way, as a result of rotating the handle 13 upward, the portion container 8 placed in the receiving portion 51 will be compressed by an upper surface 36J of the handle base portion 36K of the handle 13. Particularly, this upper surface 36J is formed as a curved compression surface. Here, a clearance is formed between the upper surface 36J and the central holding claw 53 at a position where the handle base portion 36K abuts against the upper end of the upper protruding wall 14.

As shown in FIG. 1, a lid body 71 with a waterproof function is detachably disposed on the upper portion of the mouth body 10. This lid body 71 integrally includes a lid upper portion 72 and a lid lower portion 73 that are made of a synthetic resin.

The lid upper portion 72 is configured as a cylindrical body sealed by a top panel. Specifically, this lid upper portion 72 serves to close the communication passage 17 when inserted into the mouth body 10, and integrally includes: a top panel 74; and an outer circumferential portion 75 extending downward from the circumference of the top panel 74.

Further, the lid lower portion 73 includes: a horizontally outward flange portion 77 formed on the upper end of a cylindrical portion 76; a lid inner sealing panel 78 that is disposed in the upper region inside the cylindrical portion 76 and serves to seal the cylindrical portion 76; and a lid body-side water stop member 79 that is provided on the lower end circumferential surface of the cylindrical portion 76 and composed of a rubber packing or the like. Particularly, the lid body-side water stop member 79 serves as an elastic water stop member for lid body, and has a cross-sectional surface substantially formed into the shape of “C.” More particularly, this lid body-side water stop member 79 is formed into an annular shape centering around the central axis; and is engaged with a lid body-side attachment portion 80 that serves as an attachment portion for attaching an elastic water stop member for lid body and is formed, as an annular member centering around the central axis, on the lower end circumferential surface of the lid lower portion 73. In addition, the outer circumference of the lid body-side water stop member 79 is configured to be able to abut against the inner circumferential surface of the lower cylindrical portion 16 of the mouth body 10.

As shown in FIG. 13, the lid body-side water stop member 79 has a cross-sectional surface substantially formed into the shape of “C.” Here, an inner circumferential concave portion 79A of the lid body-side water stop member 79 is tightly fitted onto and positioned to the lid body-side attachment portion 80, thus avoiding being unexpectedly removed therefrom. Further, vertically formed on the outer circumferential surface of the lid body-side water stop member 79 are curved protrusions 79B, 79B capable of tightly abutting against the lower cylindrical portion 16. Furthermore, each curved protrusion 79B of the lid body-side water stop member 79 has a cross-sectional surface that is formed into the shape of a tongue. Specifically, when engaged with the inner circumferential surface of the lower cylindrical portion 16 of the mouth body 10, the curved protrusions 79B are pressed against such inner circumferential surface in a manner such that the curved protrusions 79B are deformed upward.

Likewise, the aforementioned mouth body-side water stop member 19 has the same structure as the lid body-side water stop member 79. That is, an inner circumferential concave portion 19A thereof is tightly fitted onto and positioned to the mouth body-side attachment portion 20, thus avoiding being unexpectedly removed therefrom. Further, vertically formed on the outer circumferential surface of the mouth body-side water stop member 19 are curved protrusions 19B, 19B capable of tightly abutting against the small-diameter portion 3A.

The flange portion 77 is fixed to the under surface of the top panel 74 through, for example, ultrasonic welding, an adhesive agent or forcible fitting such that the lid upper portion 72 and the lid lower portion 73 can be integrally coupled to each other. Further, a second male screw portion 81 is provided on the outer surface of the upper protruding wall 14, and formed on the inner surface of the outer circumferential portion 75 of the lid body 71 is a second female screw portion 82 allowing the second male screw portion 81 to engage therewith. The engagement of these male screw portion 81 and female screw portion 82 allows the lid body 71 to be detachably installed in the mouth body 10.

The method for using the compression system 1 is described hereunder. After removing the lid body 71, the portion container 8 is to be placed upside-down by positioning the portion container body 61 thereof in the receiving portion 51. With the portion container 8 being placed in such manner, the peeling induction portion 65 faces the communication passage 17 (FIG. 8). That is, in such configured state, the peeling induction portion 65 is located between the receiving claw portions 54, 54, and a lower space 83 is formed below the peeling induction portion 65. Particularly, this lower space 83 is defined by the inner space of the main container 2 and a section of the lower cylindrical portion 16 that is below the receiving portion 51.

In addition, as shown in FIG. 8, with the portion container 8 facing downward, one end of the flange portion 62 of the portion container 8 is mounted on the upper surfaces 54J of the left and right receiving claw portions 54, 54, and the central region of the flange portion 62 in the left-right direction is to be inserted into as well as positioned under the under surface 53K of the central holding claw 53. There, the other end of the flange portion 62 (left end in FIG. 8) is either in contact with the inner surface of the upper protruding wall 14 or positioned in the vicinity thereof. Under this circumstance, the other end of the flange portion 62 is actually positioned below the upper end of the upper protruding wall 14 in the upper end region thereof.

In this way, with the portion container 8 being positioned in the receiving portion 51, the holding portion 55 engages with the vertical groove portion 69 formed in the central region of the portion container body 61 in the left-right direction; the flange portion 62 is held by the receiving claw portions 54 on both the left and right sides. For these reasons, the portion container 8 can be stably supported.

Meanwhile, if one mistakenly tries to place the other end of the flange portion 62, which is opposite to the sharp-pointed protrusion 68, in the receiving portion 51, the central holding claw 53 will abut against the portion container body 61 of the portion container 8, preventing the flange portion 62 from being properly mounted onto the upper surface 54J of the receiving claw portions 54 without a hitch. The user, therefore, can avoid misplacing the portion container 8 with a wrong orientation.

Next, the user unlocks the handle 13 by manipulating the locking member 41 such that the handle 13 is allowed to be swung upward. There, as shown in FIG. 8, the upper surface 36J of the handle 13 will come into contact with the bottom surface portion 66 of the portion container 8 once the handle front end portion 36S has become substantially perpendicular. At that time, by applying a force to rotate the handle front end portion 36S downward, the bottom surface portion 66 will be pressurized and squeezed substantially in parallel with the flange portion 62. For this reason, a pressure inside the portion container body 61 increases, thereby causing a part of the seal lid 63 around the peeling induction portion 65 to be removed from the portion container body 61, thus allowing the content to be obliquely ejected downward. Particularly, the direction in which the content is to be ejected is either substantially along the extended line of the flange portion 62 or slightly therebelow.

In such case, the handle 13 swings around the rotation center shaft 34. Specifically, the user manipulates the handle front end portion 36S such that the portion container 8 can be pressed by the upper surface 36J that is located closer to the rotation center shaft 34 than a manipulation point. That is, the content is allowed to be pushed out with a small force by applying the principle of leverage. Further, a force is easily applied since the portion container body 61 is pressed by the action of pushing the handle front end portion 36S downward.

In this way, for example, a hot water can be contained in the container 2, and the portion container 8 may contain a condensed soup. Here, by manipulating the handle 13 at the time of need, the condensed soup in the portion container 8 can be mixed into the hot water such that the user is allowed to drink a warm soup. Further, the portion container 8 may contain a condensed beverage. In such case, by manipulating the handle 13 at the time of need, the condensed beverage in the portion container 8 can be mixed into a water such that the user is allowed to drink a cold beverage. Furthermore, the container 2 may contain a coffee, and the portion container 8 may contain, for example, a milk and/or sugar. There, the user, at the time of need, is allowed to drink coffee by mixing the milk and sugar thereinto. However, the content may be a substance other than a liquid. In fact, the content may be a granular substance such as sugar or the like, and it is preferred that the content be the one having a fluidity such as a liquid or granular substance.

According to the present embodiment, provided is a portion container compression system including a mouth body 10 as a system main body. Specifically, the mouth body 10 has: a receiving portion 51 for installing the portion container 8; and a rotatable handle 13. The portion container 8 includes a peeling induction portion 65 as an easily unsealable portion, and is to be compressed, when installed in a receiving portion 51, by swinging the handle 13. That is, by applying the principle of leverage, the portion container 8 can be squeezed by the handle 13, thereby improving a convenience and allowing the system to be formed compact as compared to a rotary apparatus. Further, the handle 13 can also be used to carry the system, thus improving a convenience as well.

Also, according to the present embodiment, since the portion container 8 is to be obliquely installed in the receiving portion 51, the content ejected therefrom hardly splashes. In fact, not only the flange portion 62, but the bottom surface portion 66 is to be obliquely positioned as well.

Still also, according to the present embodiment, since the receiving portion 51 is located below the rotation center shaft 34 of the handle 13, the portion container 8 is to be pushed by the handle 13 having the rotation center shaft 34 that is located above the receiving portion 51, thereby causing the portion container 8 to be compressed by the pushing force of the handle 13, thus allowing forces to be applied easily.

Further, according to the present embodiment, since the mouth body 10 serving as a system main body can be disposed on or attached to the container 2, a condensed beverage of the squeezed portion container 8 can be diluted by a water or hot water. Here, when diluted by water, ice can be added thereto whenever necessary, thus making it possible to prepare a beverage

Furthermore, according to the present embodiment, since there is provided the mouth section 14A that is disposed in the region above the receiving portion 51 and severs as a mouth for drinking, the user is allowed to directly drink the beverage in the container 2, thus further improving the convenience

Moreover, according to the present embodiment, since the lid body 71 with the waterproof function is provided on the upper portion of the mouth body 10 serving as a system main body, the beverage prepared can be carried with the lid body 71 shut, thus further improving the convenience.

Also, according to the present embodiment, since the handle 13 is fixed by the locking mechanism 40 at the initial position, the system can be carried and the user can drink the beverage with the handle 13 being fixed.

Further, according to the present embodiment, since the locking mechanism 40 is disposed under the handle 13, not only the handle 13 can be easily unlocked, but a superior design feature can be achieved with a small amount of influence on the appearance.

Furthermore, according to the present embodiment, since the cutout section 70 is formed in the region of the mouth section 14A for drinking that corresponds to a swinging location of the handle 13, not only the rotational center of the handle 13 can be lowered, but the portion container 8 is allowed to be installed in a deeper location, thus achieving a high designability and saving space.

Moreover, as an effect of the embodiment, since the mouth body 10 and the ring portion 11 are detachably attached to the container 2, the mouth body 10 and the ring portion 11 can be removed therefrom and then washed. Also, since the ring portion 11 is provided with the ring portion-side cutout section 70B formed at the swinging location of the handle 13, a wide swinging range of the handle 13 can be secured. The locking mechanism 40 serves to automatically lock the handle 13 once the unlocked handle 13 has been swung to the initial position. Particularly, the locked state is established as the downward protrusion 42 engages with the through hole 47. Further, since the locking member 41 of the locked state is substantially received in the concave portion 43, the handle 13 is superior in appearance and design. Further, since the protrusions 46D are formed on the locking member 41, the location of the control portion 46S can be easily identified by touching the protrusions 46D. Moreover, since there is also provided the lid body 71, the cutout section 70 can be hidden thereby. In addition, since the concave portion 43 is provided in the lower region of the handle 13, the locking mechanism 40 can be received therein.

### Second Embodiment

FIG. 15 shows in detail a second embodiment of the present invention, in which elements identical to those of the first embodiment are denoted by identical symbols, and the descriptions thereof are thus omitted. In this embodiment, the bottom surface portion 66 is not parallel to the flange portion 62, but formed at a given angle thereto. Particularly, the bottom surface portion 66 is so configured that the region opposite to where the peeling induction portion 65 is formed slants toward the flange portion 62. Here, by swinging the handle 13 toward the compression direction, the portion container 8 can be compressed as the curved upper surface 36J pushes the bottom surface portion 66 substantially parallel.

However, the present invention is not limited to the aforementioned embodiments. In fact, various modified embodiments are possible within the scope of the present invention. For example, although the aforementioned embodiments use a substantially cylindrical container and system main body, a square container and system main body may be used as well. Further, the easily unsealable portion is not limited to that disclosed in the aforementioned embodiments. In fact, various kinds of easily unsealable portions can be used. Furthermore, the rotation center shaft integrally disposed in the handle may be rotatably attached to the main container body.

What is claimed:

1. A portion container compression system comprising:
a system main body;
a portion container including an easily unsealable portion;
a receiving portion for installing the portion container on the system main body; and
a rotatable handle, wherein
the portion container installed in the receiving portion is allowed to be compressed by swinging the handle.

2. The portion container compression system according to claim 1, wherein the portion container is obliquely installed in the receiving portion.

3. The portion container compression system according to claim 1, wherein the receiving portion is located below a rotation center shaft of the handle.

4. The portion container compression system according to claim 2, wherein the receiving portion is located below a rotation center shaft of the handle.

5. The portion container compression system according to claim 1, wherein the system main body is disposed on a main container.

6. The portion container compression system according to claim 2, wherein the system main body is disposed on a main container.

7. The portion container compression system according to claim 3, wherein the system main body is disposed on a main container.

8. The portion container compression system according to claim 5, further comprising a mouth provided in a region above the receiving portion for drinking a beverage in the main container.

9. The portion container compression system according to claim 6, further comprising a mouth provided in a region above the receiving portion for drinking a beverage in the main container.

10. The portion container compression system according to claim 7, further comprising a mouth provided in a region above the receiving portion for drinking a beverage in the main container.

11. The portion container compression system according to claim 1, further comprising a lid body with a waterproof function provided on an upper portion of the system main body.

12. The portion container compression system according to claim 2, further comprising a lid body with a waterproof function provided on an upper portion of the system main body.

13. The portion container compression system according to claim 3, further comprising a lid body with a waterproof function provided on an upper portion of the system main body.

14. The portion container compression system according to claim 1, wherein a locking mechanism locks the handle at an initial position.

15. The portion container compression system according to claim 2, wherein a locking mechanism locks the handle at an initial position.

16. The portion container compression system according to claim 3, wherein a locking mechanism locks the handle at an initial position.

17. The portion container compression system according to claim 14, wherein the locking mechanism is disposed under the handle.

18. The portion container compression system according to claim 8, wherein a cutout section is formed in a portion of the mouth where the swinging handle is to be received.

19. The portion container compression system according to claim 9, wherein a cutout section is formed in a portion of the mouth where the swinging handle is to be received.

20. The portion container compression system according to claim 10, wherein a cutout section is formed in a portion of the mouth where the swinging handle is to be received.
